(19) United States
(12) Patent Application Publication
(10) Pub. No.: US 2017/0024298 A1
(43) Pub. Date: Jan. 26, 2017

(54) IN-SYSTEM PROM EMULATOR BOARD

(71) Applicant: U.S.A. as represented by the Administrator of the National Aeronautics and Space Administration, Washington, DC (US)

(72) Inventors: ALESSANDRO D. GEIST, Bethesda, MD (US); David J. Petrick, Severna Park, MD (US)

(21) Appl. No.: 14/808,001

(22) Filed: Jul. 24, 2015

(51) Int. Cl. G06F 11/26

(52) U.S. Cl. CPC G06F 11/261

(57) ABSTRACT

Apparatus for in-system emulation of a target non-volatile memory device, such as a target PROM that stores FPGA configuration files and general data. The in-system emulation apparatus serves as stand-in hardware for the target PROM within the target system, mounted within a surface mount footprint and within volume constraints of the target PROM in the target system. The apparatus for in-system PROM emulation includes a device converter, and a surface mount emulator foot. The device converter includes at least one reprogrammable memory device, which stores developmental data that emulates data stored by the target PROM. The device converter includes a device converter circuit board, secured to the surface mount emulator foot. The device converter may include four Flash PROM reprogrammable devices, mounted above and below the device converter circuit board. The surface mount emulator foot includes an emulator foot circuit board, and a surface mount package emulation adapter.

### STATEMENT REGARDING FEDERALLY SPONSORED RESEARCH OR DEVELOPMENT

The invention described herein was made by employees of the United States Government and may be manufactured and used by or for the Government of the United States of America for governmental purposes without the payment of any royalties thereon or therefore.

### TECHNICAL FIELD

The present disclosure relates generally to hardware emulation, and more specifically, to apparatus for in-system emulation of non-volatile memory devices.

### BACKGROUND

It is known to use hardware emulation techniques in the development of one-time programmable PROM memory devices, and other non-volatile memory devices. In integrated circuit design, hardware emulation is the process of imitating the behavior of one or more pieces of hardware under development using another piece of hardware. Often in hardware emulation, the one or more pieces of hardware under development, sometimes called target hardware, is emulated during development of a system incorporating the hardware, sometimes called the target system. As applied in development of non-volatile memories, such as PROMs, hardware emulation techniques can avoid the need to burn numerous pre-production PROMs during the development process.

Hardware emulation systems for non-volatile memories, such as PROMs, typically employ a special purpose emulation system, such as an emulator device that includes a probe or other connector that is designed to communicate with a socket or other footprint of the PROMs. Because of the need for additional hardware, such as emulation electronics, wiring, and probes or other electrical interfaces, conventional PROM emulation systems can be quite bulky.

In various applications, it is necessary to test a target system including a target non-volatile memory device as an integral system with the target non-volatile memory secured within the system, e.g., in tests such as environmental tests. Conventional non-volatile memory emulation systems may not be usable where the extent of a conventional non-volatile memory emulation system is incompatible with volume constraints of the target system; or where it is necessary to emulate and test a target non-volatile memory component embedded within its target system. This is particularly true when the target non-volatile memory component occupies a limited volume and footprint within the target system.

### SUMMARY

Various non-volatile memory components (herein sometimes called “NVM”) are commonly known as read-only memory (“ROM”), programmable ROM (“PROM”), erasable PROM (“EPROM”), and electrically erasable PROM (“EEPROM”) integrated circuit (“IC”) chips. Other examples of NVM components include Flash memory, magnetoresistive random-access memory (MRAM), phase-change memory or “C-RAM” non-volatile memory, and Nano-RAM computer memory technology (“NRAM”). The present disclosure generally refers to embodiments involving in-system emulation of PROM devices, but references herein to in-system PROM emulation may also include in-system emulation of other NVM devices.

The embodiments described herein describe an apparatus for in-system emulation of a PROM memory device that permits development and testing of an emulated PROM installed within a target system, including target systems with severe volume constraints. The embodiments described herein describe an apparatus for in-system emulation of a PROM memory device, and applications of this apparatus. The in-system PROM emulation apparatus allows the design, prototyping and testing of a target PROM, wherein the in-system emulation apparatus serves as stand-in hardware for the target PROM within a target system. As stand-in hardware for the target PROM, the in-system PROM emulation apparatus is mounted within a surface mount footprint of the target PROM within the target system, and fits within length, width, and height constraints (i.e., volume constraints) of the target PROM within the target system.

In one embodiment, an apparatus for in-system emulation of a target programmable read-only memory (PROM) in a target system, the target PROM being a one-time programmable non-volatile memory device that stores data, and the target PROM being mounted to a surface mount footprint within a volume of the target PROM in the target system, the apparatus comprises a device converter including a device converter circuit board and at least one reprogrammable memory device electrically and mechanically coupled to the device converter circuit board; and a surface mount emulator foot secured to the device converter circuit board, the surface mount emulator foot having a developmental surface mount footprint that emulates the surface mount footprint of the target PROM, and the device converter and surface mount emulator foot fitting within the volume of the target PROM in the target system, the device converter and surface mount emulator foot provide electrical interface routing between device terminals of the at least one reprogrammable memory device and footprint terminals of the surface mount emulator foot to route developmental data stored by the reprogrammable memory device from the device terminals of the at least one reprogrammable memory device to the footprint terminals of the surface mount emulator foot, the developmental data stored by the reprogrammable memory device emulating the data stored by the target PROM.

In another embodiment, an apparatus for in-system emulation of a target programmable read-only memory (PROM) in a target system, wherein the target PROM is a one-time programmable non-volatile memory device that stores configuration data for configuring the target system and that stores programming data for programming the target system, and wherein the target PROM is a small-outline package (SOP) device mounted to a surface mount footprint in the target system, the apparatus comprises a device converter including a device converter circuit board and a plurality of reprogrammable memory devices electrically and mechanically coupled to the device converter circuit board, the plurality of reprogrammable memory devices configured to store developmental configuration data that emulate the configuration data of the target PROM and store developmental programming data that emulate the programming data stored by the target PROM; and a surface mount emulator foot secured to the device converter circuit board, the surface mount emulator foot having a developmental surface mount footprint that is configured to emulate the surface mount footprint of the target PROM, the device converter and surface mount emulator foot configured to route the developmental configuration data and the developmental programming data from the plurality of reprogrammable memory devices to the surface mount emulator foot.

Additional features and advantages of an embodiment will be set forth in the description which follows, and in part will be apparent from the description. The objectives and other advantages of the invention will be realized and attained by the structure particularly pointed out in the exemplary embodiments in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

Non-limiting embodiments of the present disclosure are described by way of example with reference to the accompanying figures which are schematic and are not intended to be drawn to scale. Unless indicated as representing the background art, the figures represent aspects of the disclosure.

FIG. 1 illustrates a top view of a surface mount emulator foot of an in-system PROM emulation apparatus, according to an embodiment.

FIG. 2 illustrates a side view of a surface mount emulator foot of an in-system PROM emulation apparatus, according to the embodiment.

FIG. 3 illustrates a bottom view of a surface mount emulator foot of an in-system PROM emulation apparatus, according to the embodiment.

FIG. 4 illustrates an end view of a surface mount emulator foot of an in-system PROM emulation apparatus, according to the embodiment.

FIG. 5 illustrates an isometric view of a surface mount emulator foot of an in-system PROM emulation apparatus, according to the embodiment.

FIG. 6 illustrates a top view of a device converter of an in-system PROM emulation apparatus, according to an embodiment.

FIG. 7 illustrates a bottom view of a device converter of an in-system PROM emulation apparatus, according to the embodiment.

FIG. 8 illustrates an elevation view of an in-system PROM emulation apparatus, according to an embodiment.

FIG. 9 illustrates an isometric view of an in-system PROM emulation apparatus, according to the embodiment.

FIG. 10 is a circuit schematic diagram illustrating an exemplary in-system FLASH PROM reprogrammable memory, with bypass capacitors, according to an embodiment.

FIG. 11 is a circuit schematic diagram illustrating exemplary surface mount emulator foot terminal assignments, according to an embodiment.

FIG. 12 is a circuit schematic diagram illustrating an exemplary voltage regulator for a device converter, and exemplary JTAG test port connectors for an in-system PROM emulation apparatus, according to an embodiment.

### DETAILED DESCRIPTION

The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here. Furthermore, the various components and embodiments described herein may be combined to form additional embodiments not expressly described, without departing from the spirit or scope of the invention.

Reference will now be made to the exemplary embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to one skilled in the relevant art and having possession of this disclosure, are to be considered within the scope of the invention.

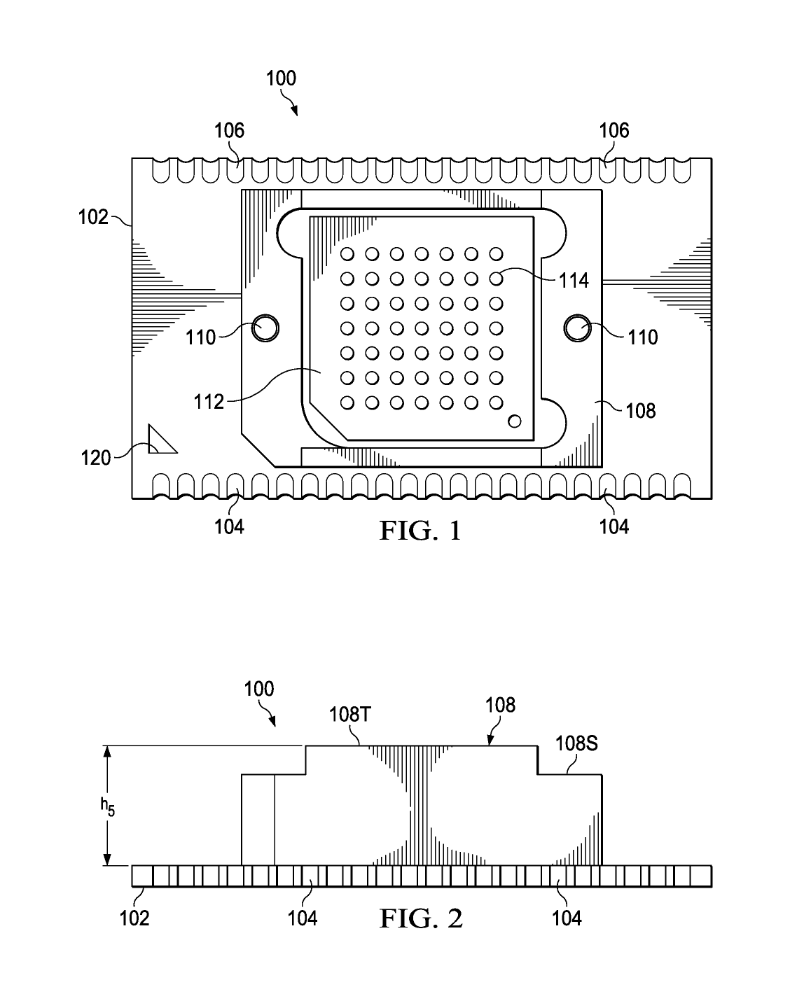

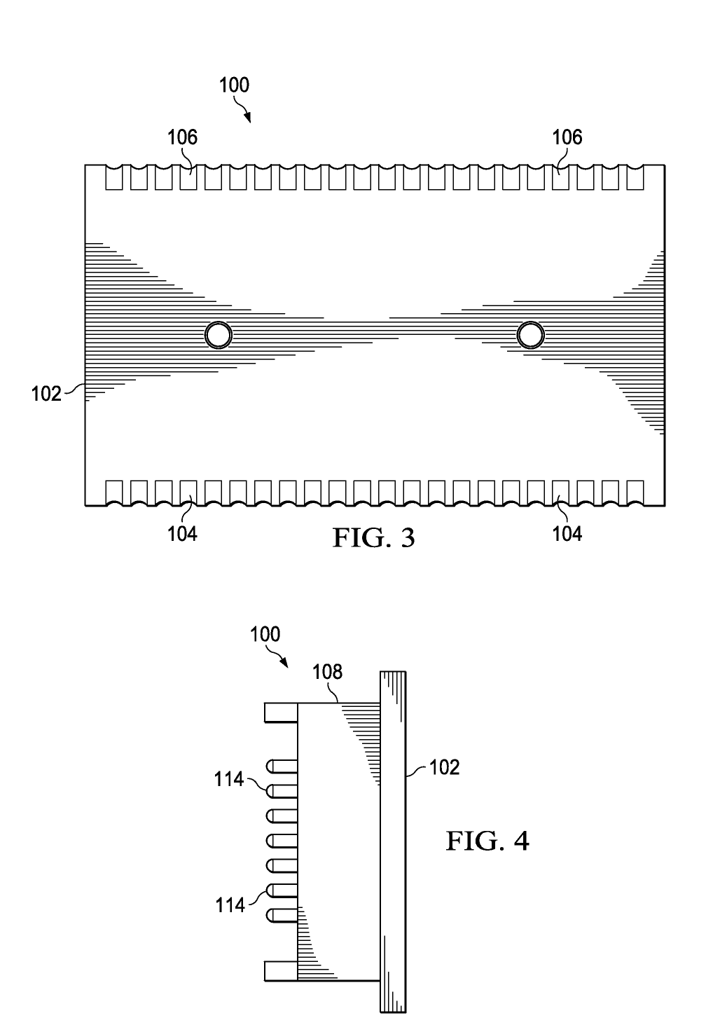

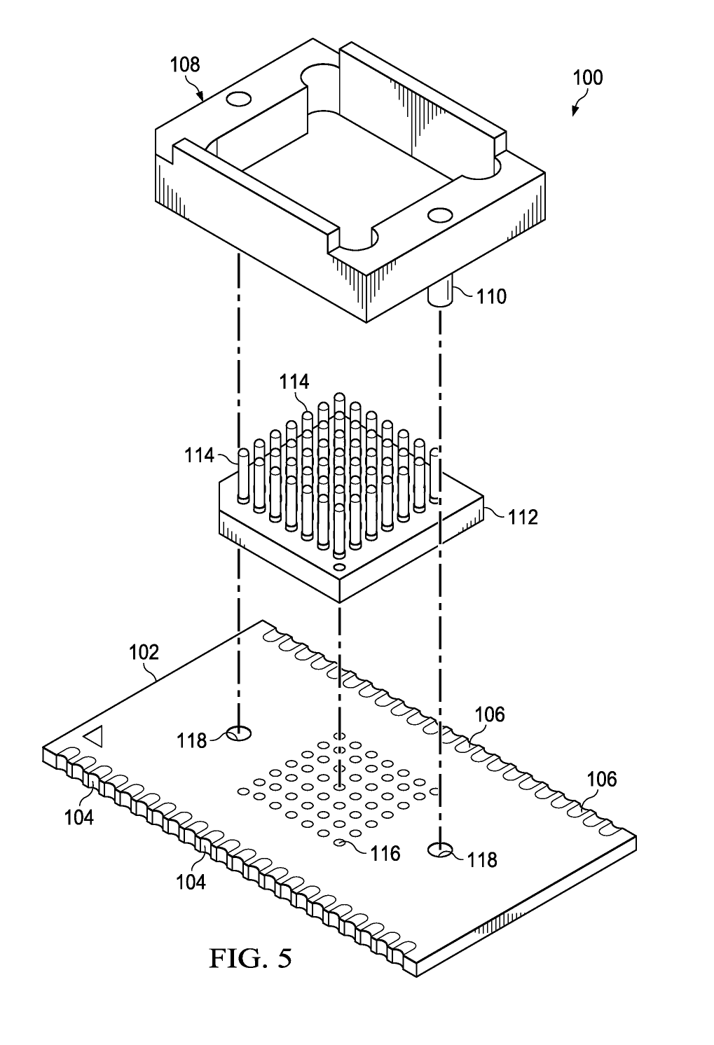

FIGS. 1-9 illustrate apparatus 240 for in-system emulation of a target non-volatile memory device (generally called in-system PROM emulator 240, and in-system PROM emulator board 240, in the present disclosure). In an embodiment, the target non-volatile memory device is a one-time programmable non-volatile PROM device, it being understood that the principles of the present disclosure also generally apply to in-system emulation of other non-volatile memory devices. Apparatus 240 for in-system emulation of the target PROM includes as its principle subassemblies, a surface mount emulator foot 100, and a device converter 200. Surface mount emulator foot 100 serves as a foot or base structure of apparatus 240, substantially matches the footprint of a target PROM, and provides mechanical and electrical interface with a target system. Device converter 200 carries one or more reprogrammable memory devices (as illustrated, four reprogrammable memory devices 204, 206, 214, and 216). In an embodiment, reprogrammable memory devices 204, 206, 214, and 216 store developmental data that emulate data stored by the target PROM, and these reprogrammable memory devices may also emulate the speed and functionality of the target PROM.

The reprogrammable memory devices of in-system PROM emulator 240 enable development of the target PROM without requiring consumption (burning) of numerous PROMs during the development process. The reprogrammable memory devices (also called in-system reprogrammable memory devices in the present disclosure) can be reprogrammed as many times as required for a development program, allowing the reprogrammable memory devices to be iteratively tested with no need to replace memory devices of the in-system PROM emulator. It is only when the final design of the target PROM has been thoroughly tested using in-system PROM emulator 240 that this design is burned into the target PROM and the emulator is replaced with the target PROM. Similarly, for in-system emulation of NVM technologies other than PROM, the target NVM device may be produced or written with the final design only when that design has been thoroughly tested by in-system emulation.

Furthermore, repeated removal and replacement of the target PROM (or other target NVM) can wear away the circuit board containing this PROM, and can cause permanent damage to the PROM footprint at this circuit board. The present in-system emulation apparatus requires only a single rework cycle—install PROM emulator hardware; remove PROM emulator hardware; install target PROM (or other target NVM)—thereby avoiding the risks of wear and damage to the circuit board caused by repeated removal and replacement of the target PROM (or other target NVM).

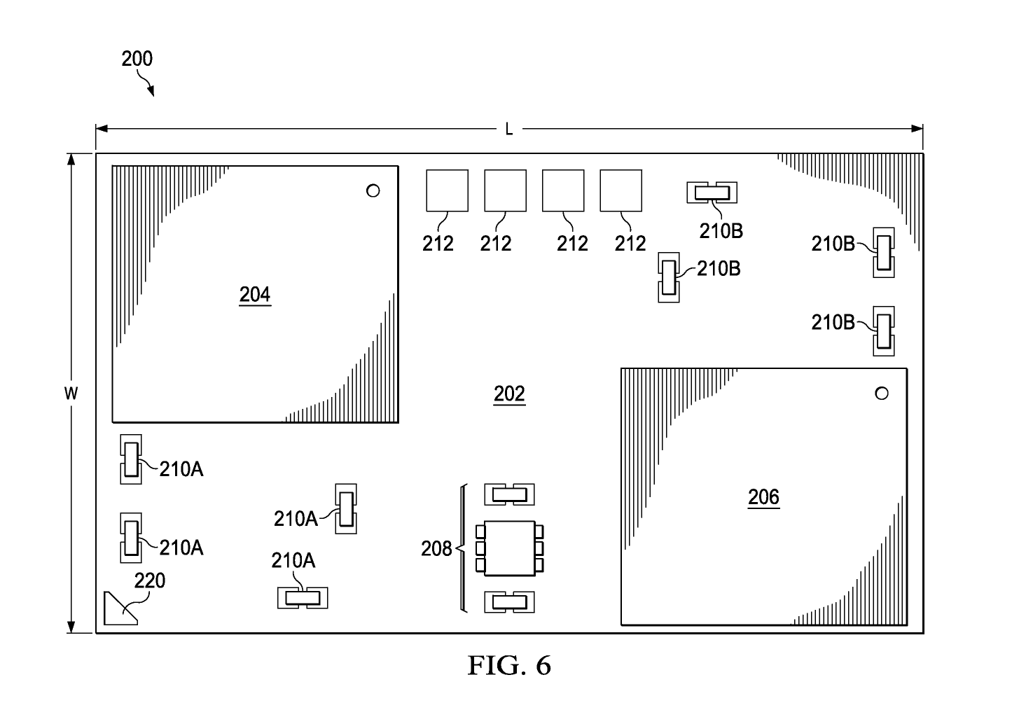

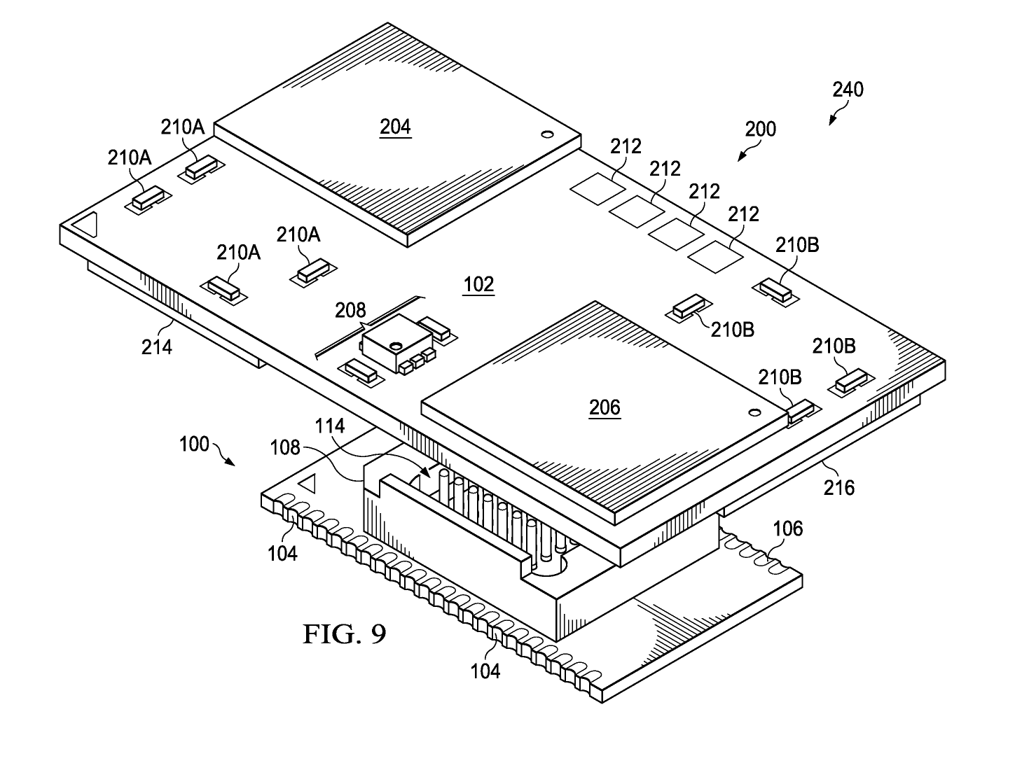

Surface mount emulator foot 100 is secured to device converter 200 to form the in-system PROM emulator 240. In an advantageous approach to hardware emulation of PROM devices, in-system PROM emulator 240 acts as a stand-in hardware emulator during development of the target PROM and the target system containing that PROM. As stand-in hardware, the in-system PROM emulator 240 is mounted within a surface mount footprint of the target PROM within the target system. Furthermore, the in-system PROM emulator 240 fits within length, width, and height constraints (also herein called volume constraints) of the target PROM within the target system, such as requirements of physical separation of the target PROM from adjacent components of the target system. In an embodiment as seen in FIG. 9, length (L) and width (W) dimensions of device converter 200 (FIG. 6) may extend beyond the surface mount footprint of the surface mount emulator foot 100, as long as these dimensions remain within length and width constraints of the target PROM as stand-in hardware in the target system.

As used in the present disclosure, a “target PROM” is a non-volatile memory device (NVM) under development, and a “target system” is a system incorporating the target PROM. In one embodiment, the target PROM is a one-time programmable PROM device under development. As used in the present disclosure, “development” and variants such as “develop” encompass various aspects or phases of product development such as design, programming, prototyping (design verification), and testing. As used in the present disclosure, “in-system emulation” refers to the emulation of a target PROM embedded within its target system, e.g., during testing.

In an embodiment, the target system is the SpaceCube™ spaceflight processing system disclosed, e.g., in U.S. Patent Publication No. 20130181809 A1, entitled “SpaceCube MINI,” which is hereby incorporated by reference in its entirety. This patent application discloses a miniature cube processing system for on-board spacecraft processing. In an embodiment, the target system is SpaceCube 2.0, a compact, high-performance, low-power onboard processing system that incorporates hybrid processing elements including a central processing unit (CPU), field programmable gate array (FPGA), and digital signal processor (DSP). In an embodiment, program execution can be reconfigured in real time and algorithms can be updated, modified, and/or replaced at any point during a spaceflight mission.

In an embodiment, SpaceCube 2.0 possesses compact size specifications (5×5×7 in. (≈12.7×12.7×17.8 cm)). As a result of this highly compact design, in-system emulation of hardware of this target system (i.e., the target PROM) requires that the in-system emulator fit within limited volume constraints of the target PROM, including not only the target PROM footprint, but also its height. This illustrates that depending on requirements of the target system, volume constraints of a target PROM in a target system, also herein called volume of the target PROM in the target system, may be more or less limited and may be comparable to or greater than the length, width, and height specifications of the target PROM itself.

In an embodiment, PROM memory devices of the target system (i.e., target PROM) are used for CPU boot, health and safety, and basic command and telemetry functionality in the SpaceCube 2.0 system. In one embodiment, the target PROM is a 3D PLUS™ programmable ROM (PROM) module, part number 3DPO64M08VS2299, supplied by 3D PLUS USA, Inc., McKinney, Tex. The 3D PLUS™ PROM is a 64 Mbit PROM, organized as 8M×8. The 3D PLUS™ PROM module is a 3.3V device. It is non-volatile, one-time-programmable, read only memory, designed to store configuration bitstreams of FPGA devices. The 3D PLUS™ PROM module is also designed for general data storage functions, such as processor boot PROM, and storage of data parameters.

The 3D PLUS™ PROM provides dual configuration modes: serial configuration (up to 264 Mb/s) and parallel (up to 264 Mb/s at 33 MHz). When the FPGA is in Master Serial mode, it generates a configuration clock that drives the module. A short access time after the rising clock edge, data appears on the module DATA output pin that is connected to the FPGA DIN pin. The FPGA generates the appropriate number of clock pulses to complete the configuration. Once configured, it disables the module. When the FPGA is in Slave Serial mode, the module and the FPGA are both clocked by an incoming signal. When the FPGA is in Master SelectMAP mode, it generates a configuration clock that drives the module and the FPGA. After the rising CCLK edge, data are available on the module DATA (D0-D7) pins. In an embodiment, the data will be clocked into the FPGA on the following rising edge of the CCLK. When the FPGA is in Slave SelectMAP mode, the module and the FPGA both are clocked by an incoming signal. In an embodiment, a free-running oscillator is used to drive CCLK.

In another embodiment, the target PROM is a 128 Mbit 3D PLUS™ programmable ROM (PROM) module, part number 3DPO128M08VS4667. This 128 Mbit 3D PLUS™ PROM is organized as 16M×8. It has the same footprint as the 64 Mbit PROM, but a greater height than the 64 Mbit PROM.

The 64 Mbit and 128 Mbit 3D PLUS™ target PROMs stack vertically, a characteristic that imposes tight length and width constraints for the in-system PROM emulator.

In an embodiment, the 3D PLUS™ PROM is deployed within the SpaceCube 2.0 target system to configure two Virtex-5 field-programmable gate array (FPGA) parts (Virtex-5™ FPGA parts are supplied by Xilinx, Inc., San Jose, Calif.). 3D PLUS™ PROM also can configure other Xilinx FPGA devices, and can program Xilinx FPGA devices during a spaceflight mission.

In an embodiment, other exemplary computing power specifications for the SpaceCube 2.0 target system include four PowerPC 440 RISC processors (1100 DMIPS each), 500+DSP48Es (2×580 GMACS), 100+LVDS high-speed serial I/Os (1.25 Gbps each), and 2×190 GFLOPS single-precision (65 GFLOPS double-precision) floating point performance. Additionally the SpaceCube 2.0 target system may include RAM memory for program execution, and FLASH/EEPROM memory to store algorithms and application code for the CPU, FPGA, and DSP processing elements.

In an embodiment, various components of in-system PROM emulator 240, including reprogrammable memory devices of device converter 200, the footprint and pin assignments of surface mount emulator foot 100, and interface routing between these components, are designed to emulate the serial configuration and parallel configuration functions of the 3D PLUS™ PROM as well as other functions of the 3D PLUS™ PROM. In addition to configuration of FPGA devices, the reprogrammable memory devices of device converter 200 may store programming data to emulate programming data stored by the 3D PLUS™ PROM and used for various mission functions such as health and safety, basic command and telemetry. The reprogrammable memory devices of device converter 200 may emulate data-storage functions of the 3D PLUS™ target PROM such as storage of FPGA hardware Bootloader, or processor boot code; and storage of general data parameters. In addition, during development of the target system, in-system PROM emulator 240 can use configuration data stored by the reprogrammable memory devices of device converter 200 to directly configure field-programmable gate array (FPGA) devices of the target system, such as FPGA devices supplied by Xilinx, Inc.

In an embodiment, in-system PROM emulator 240 incorporates XILINX® XCF32P Flash In-System PROM devices as reprogrammable memory devices of device converter 240 (XILINX is a trademark of Xilinx, Inc., San Jose, Calif.). Xilinx® XCF32P Flash Programmable PROMs are designed for configuration of Xilinx FPGAs, as well as for general data storage, and are available in small-footprint 0.8 mm pitch, 48 ball BGA packages (ball grid array part). Xilinx® XCF32P Flash Programmable PROMs are cascadable for storing longer or multiple bitstreams.

In an embodiment, in-system PROM emulator 240 incorporates four Xilinx® XCF32P Flash In-System PROM reprogrammable memory devices 204, 206, 214, and 216 to support in-system emulation of both 3D PLUS™ 3DPO64M08VS2299 programmable ROM (PROM) module, a 64 Mbit PROM; and 3D PLUS™ 3DPO128M08VS4667 programmable ROM (PROM) module, a 128 Mbit PROM. While two Xilinx® XCF32P Flash In-System PROMs are sufficient to emulate the 64 Mbit PROM, in-system PROM emulator 240 includes the four Xilinx® XCF32P Flash In-System PROMs in order to emulate the 128 Mbit PROM. As described below, in-system PROM emulator 240 arrays these four in-system reprogrammable PROM devices and other components within a compact form factor suitable for mounting within the surface mount footprint, and for fitting within volume constraints, of the 3D PLUS™ programmable ROM (the target PROM).

Turning to FIGS. 1-5, surface mount emulator foot 100 is a major subassembly of in-system PROM emulator 240 that emulates the electrical interface of the target PROM within the target system, and provides a surface mount mechanical interface emulating the surface mount footprint of the target PROM. Surface mount emulator foot 100 includes an emulator foot printed circuit board (PCB) 102. In an embodiment, emulator foot PCB 102 has 44 position leadless side castellations 104, 106, arrayed at opposing edges of the printed circuit board, which serve as footprint terminals of the surface mount emulator foot 100. Leadless side castellations 104, 106 emulate the surface mount footprint of 3D PLUS™ 3DPO64M08VS2299 programmable ROM (PROM) module, which is a 44-pin SOP-44 W2 package. PCB orientation marker 120 identifies the location of pin 1 of the footprint terminals of surface mount emulator foot 100 (i.e., the leftmost pin of leadless side castellations 104). Besides small-outline package (SOP) surface mount technologies, numerous other electronic component package technologies are known in the art. Examples of other electronic component package technologies include dual in-line package (DIP), Small Outline Integrated Circuit (SOIC), Quad Flat Package (QFP), and chip carrier package technologies such as Leaded Chip Carrier (LCC), Ceramic Leadless Chip Carrier (CLCC), Bump Chip Carrier (BCC), among many others. The emulator footprint of the present in-system PROM emulation apparatus can emulate any electronic component package type of the target PROM (including package types of NVM devices other than PROM).

In an embodiment, emulator foot PCB 102 supports a surface mount package emulator adapter 112. Surface mount package emulator adapter 112 (also called emulator adapter 112) provide interconnections to 0.8 mm pitch, 7×7 array of BGA (ball grid array) pads 116, for access to the 44 leadless side castellations 104, 106. Emulator foot PCB 102 provides custom pin mapping between the 7×7 ball grid array (BGA) 116 and the 44 leadless side castellations 104, 106. In an embodiment, emulator adapter 112 is soldered to BGA 116 using solder balls. Emulator adapter 112 includes grid array 114 for a pluggable connection to device converter 200 to provide electrical and mechanical interface between the surface mount emulator foot 100 and the device converter 200. In an embodiment, grid array 114 is a 7×7, 0.8 mm pitch micro grid array of terminal pins, which are connected electrically within emulator adapter 112 to the solder balls soldered to the 7×7 BGA contacts array 116.

In an embodiment, the surface mount package emulator adapter 112 is a Giga-snaP™ BGA 0.8 mm male surface mount foot, part number SF-BGA4NB-B-66F, supplied by Ironwood Electronics, Eagan, Minn. In this embodiment, in the 7×7, 0.8 mm pitch micro grid array of terminal pins, the pin diameter is 0.2032 mm. In an embodiment, the emulator foot printed circuit board (PCB) 102 includes a circuit board substrate, IPC 4101/21/26/83/98, with thickness 0.635±0.18 mm, and Td≧345C (per IPC standard of the Association Connecting Electronics Industries).

In an embodiment as illustrated in FIG. 1, a shroud 108 surrounds the surface mount package emulator adapter 112 and the micro grid array 114. Referring to FIGS. 2, 4, and 5, shroud 108 is configured with opposing top sections 108T that shield the micro grid array 114 at the edges of emulator foot PCB 102 including leadless side castellations 104, 106. Shroud 108 includes shoulders 108S that provide room below the top sections 108T at edges of shroud 108 along the length of emulator foot PCB 102. In an embodiment, the top sections 108T have a height Its of 3.85 mm above the top face of emulator foot PCB 102 (FIG. 2); top sections 108T have a height of 4.53 mm above the bottom face of emulator foot PCB 102 (FIG. 4); and shoulders 108S have a height h₃ of 3.49 MM mm above the bottom face of emulator foot PCB 102. In an embodiment, shroud 108 is formed from Ultem® 1000 PolyEtherlmide (PEI), an amber transparent high performance polymer that provides high strength and rigidity at elevated temperatures and long term heat resistance (Ultem® 1000 PEI is supplied by SABIC Americas, Inc., Houston Tex.). Shroud 108 is secured to emulator foot PCB 102 via alignment pins 110. In an embodiment, alignment pins 110 are 0.79 mm diameter, 3.175 mm long, chrome stainless steel pins, and may be secured within apertures 118 of emulator foot PCB 102.

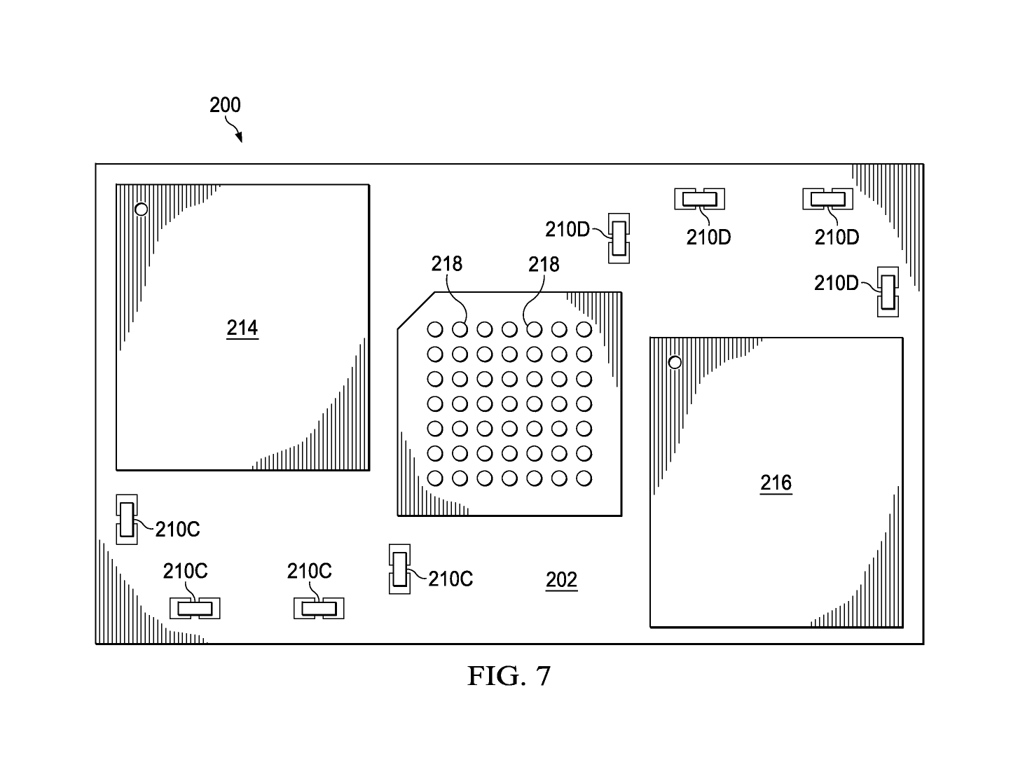

Turning to the top and bottom views of device converter 200 in FIGS. 6 and 7, device converter 200 includes a device converter PCB (printed circuit board) 202. The top side of device converter PCB (printed circuit board) 202 carries a first in-system reprogrammable memory device 204, and a second in-system reprogrammable memory device 206. The bottom side of device converter PCB 202 carries a third in-system reprogrammable memory device 214, and a fourth in-system reprogrammable memory device 216. In-system reprogrammable memory devices 204, 206, 214, and 216 emulate the memory functions of the target PROM. As previously noted, in-system reprogrammable memory devices 204, 206, 214, and 216 can be reprogrammed as many times as required during development of the target PROM, allowing the reprogrammable memory devices to be iteratively tested with no need to replace memory devices of the in-system PROM emulator 240.

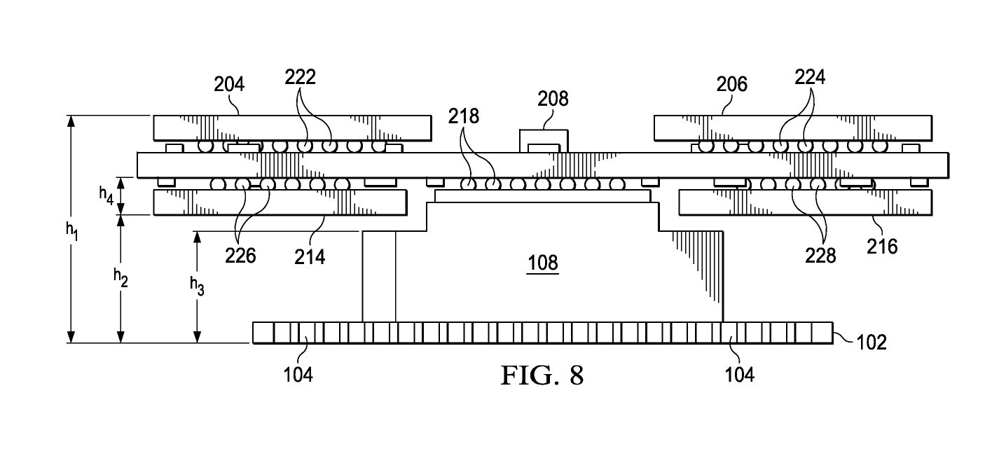

In an embodiment, the reprogrammable memory devices 204, 206, 214, and 216 are Flash PROM BGA packages. In an embodiment, reprogrammable memory devices 204, 206, 214, and 216 are XILINX® XCF32P Flash In-System PROMs, which are 0.8 mm pitch, 48 ball BGA packages. As seen in FIG. 8, an elevation view of an in-system PROM emulator 240, these small-footprint BGA packages are surface-mounted to ball grid arrays (BGA) 222, 224, 226, and 228. The physical arrangement of XILINX® XCF32P Flash PROMs 204, 206, 214, and 216 mounting two devices above, and two below, the device converter PCB 202 makes efficient use of space, so that in-system PROM emulator 240 fits within volume constraints of the target PROM within the target system. In an embodiment, open space above shoulders 108S of shroud 108 provides clearance for the XILINX® XCF32P Flash PROMs 226 and 228 at the lower face of device converter PCB 202. Illustrative dimensions in this embodiment are a 1.29 mm height h₄ of XILINX® XCF32P Flash PROMs 214 and 216 including ball grid arrays 226, 228; and a 3.93 mm height h₂ of the bottom-facing surfaces of XILINX® XCF32P Flash PROMs 214 and 216 above the lower face of surface mount emulator foot PCB 102.

In an embodiment, the overall height (h₁; also called height H in the present disclosure) of in-system PROM emulator 240 is 7.31 mm. The overall length (L=26.00±0.13 mm) and width (W=15.00±0.13 mm) of in-system PROM emulator 240 are based upon the length and width of device converter PCB 202, which extend beyond length and width of the emulator foot PCB 102 (cf. the isometric view of in-system PROM emulator 240 in FIG. 9. In an embodiment, emulator foot PCB 102 has a length of 18.54 mm and a width of 10.90 mm). These overall dimensions (L, W, H) of in-system PROM emulator 240 fit within the volume constraints of the target PROM within the target system, enabling in-system PROM emulator 240 to be installed in the target system as a stand-in device for emulation of the target PROM.

In emulation of NVM technologies other than one-time programmable PROM devices, component design and dimensional limitations (L, W, H) of an in-system emulator may be chosen as appropriate for particular requirements of the in-system NVM.

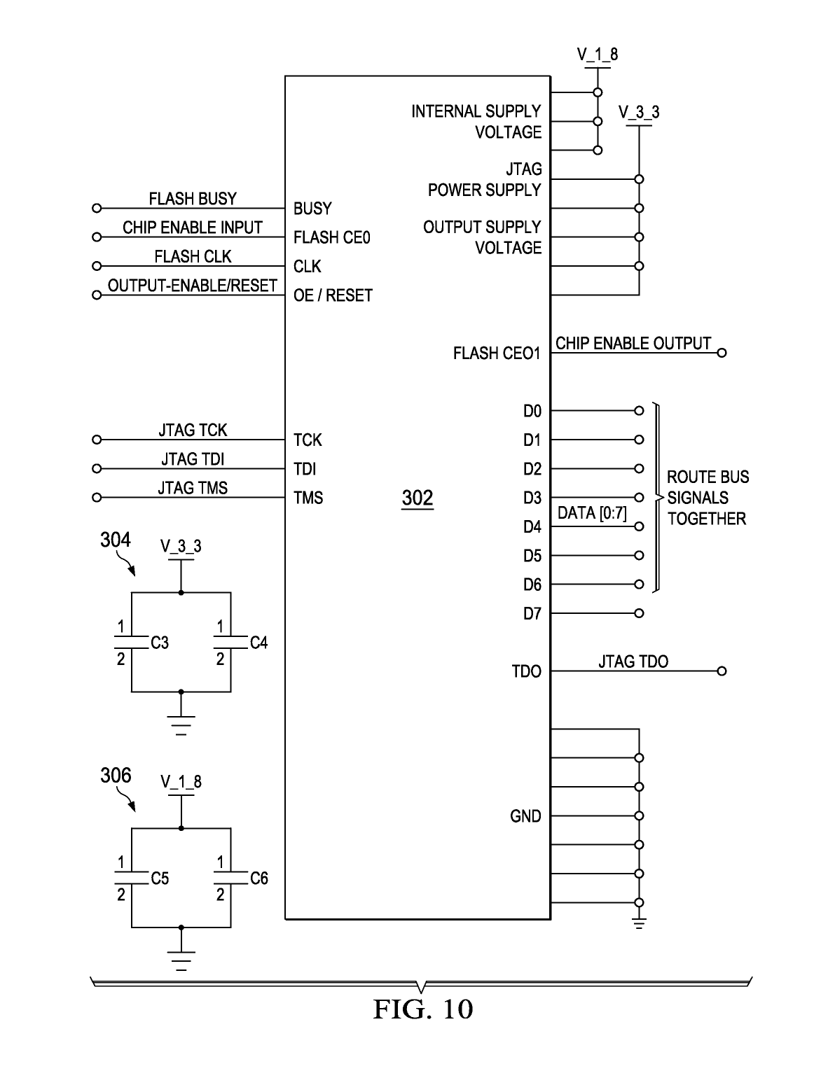

In an embodiment, device converter 200 includes a voltage regulator 208 and four sets of bypass capacitors 210A, 210B, 210B, and 210D, to provide voltage supplies for the XILINX® XCF32P Flash PROMs 204, 206, 214, and 216 (FIGS. 6, 9). In an embodiment, the in-system voltage supply for the target PROM is 3.3V, and voltage regulator 208 processes this 3.3 V supply to provide a 1.8V voltage supply as required to operate the XILINX® XCF32P Flash PROMs 204, 206, 214, and 216. In an embodiment, voltage regulator 208 incorporates circuit elements as seen at 314 in FIG. 12. Bypass capacitors 210A, 210B, 210C, and 210D filter DC voltage supplies of 3.3V and 1.8V for XILINX® XCF32P Flash PROMs 214, 216, 204, and 206, respectively. In an embodiment, each of the sets of bypass capacitors 210A, 210B, 210C, and 210D incorporate circuit elements as seen at 304 and 306 in FIG. 10.

Device converter 200 includes joint test action group (JTAG) jumpers 212, which communicate with JTAG terminals of XILINX® XCF32P Flash PROMs 204, 206, 214, and 216 to support programming, prototyping, and testing according to IEEE Standard 1149.1/1532 Boundary-Scan (JTAG), during in-system emulation of the target PROM. Test ports TP1-TP4 corresponding to JTAG jumpers 212 are seen at 318 in FIG. 12 (TP1—test port for JTAG_TCK; TP2—test port for JTAG_TDI; TP3—test port for JTAG_TMS; TP1—test port for JTAG_TDO). In an embodiment, these JTAG interfaces are used by the in-system PROM emulator 240 to reconfigure the XILINX® XCF32P Flash PROMs 204, 206, 214, and 216. The JTAG interfaces can support a JTAG chain in the target system, if included as an optional feature of the target system.

In an embodiment, the device converter printed circuit board (PCB) 202 includes a circuit board substrate, IPC 4101/21/26/83/98, with thickness 0.889±0.18 mm, and Td≧345C (per IPC standard of the Association Connecting Electronics Industries).

In an embodiment, device converter 200 includes a 7×7, 0.8 mm micro grid array 218 of female socket contacts. Selected terminals of the XILINX® XCF32P Flash PROMs 204, 206, 214, and 216 (also called device terminals in the present disclosure) are electrically connected to given contacts of the micro grid array 218 via custom pin mapping in the BGA device converter circuit board 202. Device converter printed circuit board 202 is electrically and mechanically connected to the surface mount emulator foot 100 by plugging the 7×7, 0.8 mm pitch micro grid array of terminal pins 114 of surface mount emulator foot 100 into the 7×7, 0.8 mm micro grid array of female socket contacts 218. In an embodiment, the connection of terminal pins 114 to socket contacts 218 is the only connection between surface mount emulator foot 100 and device converter 200 in assembling the in-system PROM emulator board 240. In an embodiment, terminal pins 114 are formed of a shell material of brass, and a shell finish of 10 microinch gold over 50 microinch nickel (min.). In an embodiment, female socket contacts 218 are formed of a contact material of beryllium copper, and a contact finish of 10 microinch gold over 100 microinch nickel (min.).

In an embodiment, XILINX® XCF32P Flash PROMs 204, 206, 214, and 216 provide in-system emulation of functions of the target PROM, 3D PLUS™ programmable ROM (PROM) module, part number 3DPO64M08VS2299, as a one-time programmable non-volatile device that stores Xilinx FPGA configuration files, and that can program a Xilinx FPGA as well as store general data. XILINX® XCF32P Flash PROMs 204, 206, 214, and 216 store developmental configuration data that emulate the configuration data stored by the 3D PLUS™ target PROM and developmental programming data that emulate the programming data stored by the 3D PLUS™ target PROM. FIG. 10 provides a circuit schematic diagram of selected device terminals of a XILINX® XCF32P Flash PROM 302 for emulating these functions of the 3D PLUS™ target PROM. Device terminals of the XILINX® XCF32P Flash PROM include configuration data terminals D0-D7 (DATA [0:7]). Terminals of an internal voltage supply circuit provide a 1.8V (relative to ground, GND) internal core operating voltage (VCCint) to power terminals of internal resources. Terminals of a main voltage (VCCO) supply circuit provide a 3.3V main operating voltage (VCCO) to power terminals of resources such as JTAG input buffers, JTAG output drivers, Flash input buffers, and Flash output drivers.

JTAG interfaces of PROM 302 include TDI (Test Data In); TDO (Test Data Out); TCK (Test Clock); and TMS (Test Mode Select). In an embodiment, the JTAG interfaces of Flash PROM 302 are daisy chained with JTAG interfaces of the other three Flash PROM devices (not shown), so that only one JTAG chain is needed. TMS and TCK data are common to all four devices. The TDI terminal of Flash PROM 302 feeds to this device data supplied by the TDO terminal of the prior Flash PROM device in the daisy chain. The TDO terminal of Flash PROM 302 supplies data to the TDI terminal of the next Flash PROM device in the daisy chain.

Chip Enable Input and Chip Enable Output are used in reading memory address registers of the four XILINX® XCF32P Flash PROMs. The Chip Enable Input terminal for Flash PROM 302 is FLASH CE0, and the Chip Enable Input terminal is FLASH CE2, Flash CE4, and Flash CE6 for the other three Flash PROMs, respectively (not shown in FIG. 10). A low value of Chip Enable Input terminal FLASH CE0 enables reading of memory registers of the Flash PROM 302. The Chip Enable Output terminal for Flash PROM 302 is FLASH CEO1, and the Chip Enable Output terminal is FLASH CEO3, Flash CEO5, and Flash CEO7 for the other three Flash PROMs, respectively (not shown in FIG. 10). All Chip Enable Input signals and all Chip Enable Output signals are routed to the footprint terminals of PROM emulator 240, and the target design can separately control all four Chip Enable Inputs if desired. The Chip Enable Input and Chip Enable Output lines of the four XILINX® XCF32P Flash PROMs are tied together, and instead of individual control of Chip Enable Input the target design can elect to tie the Flash PROMs together in a daisy chain. In this mode, Chip Enable Input terminal FLASH CE0 is driven by the CEO output of the prior PROM in the daisy chain. Chip Enable Output FLASH CEO1 goes low on completing reading memory address registers of Flash PROM 302, and enables the reading of memory address registers by the next Flash PROM in the daisy chain.

Another device terminal of XILINX® XCF32P Flash PROM 302 seen in FIG. 10 is a FLASH Busy signal, which may indicate if a Flash related operation is in progress (e.g., a store-to-flash process). FLASH CCLK provides the clock path during configuration of an FPGA from external Flash. The Output-Enable/Reset (OE/RESET) terminal is used to reset the Flash PROM 302.

Various components of the in-system PROM emulator 240 act as an interposer, providing provide electrical interface routing between the BGA48, 0.8 MM pitch device terminals of XILINX® XCF32P Flash PROMs 204, 206, 214, and 216, and the SOP44, 0.8 mm pitch footprint terminals of surface mount emulator foot 100. Segments of the electrical interface routing include: custom pin mapping by the device converter PCB 202 from the BGA48 device terminals to the micro-grid array 218; mating interconnections between the micro grid arrays 218 and 114; electrical interface routing by the surface mount package emulator adapter 112 from the micro grid array 114 to the 7×7 ball grid array (BGA) 116; and custom pin mapping by the emulator foot printed circuit board (PCB) 102 from the 7×7 BGA 116 to the SOP44 footprint terminals of the surface mount emulator foot 100.

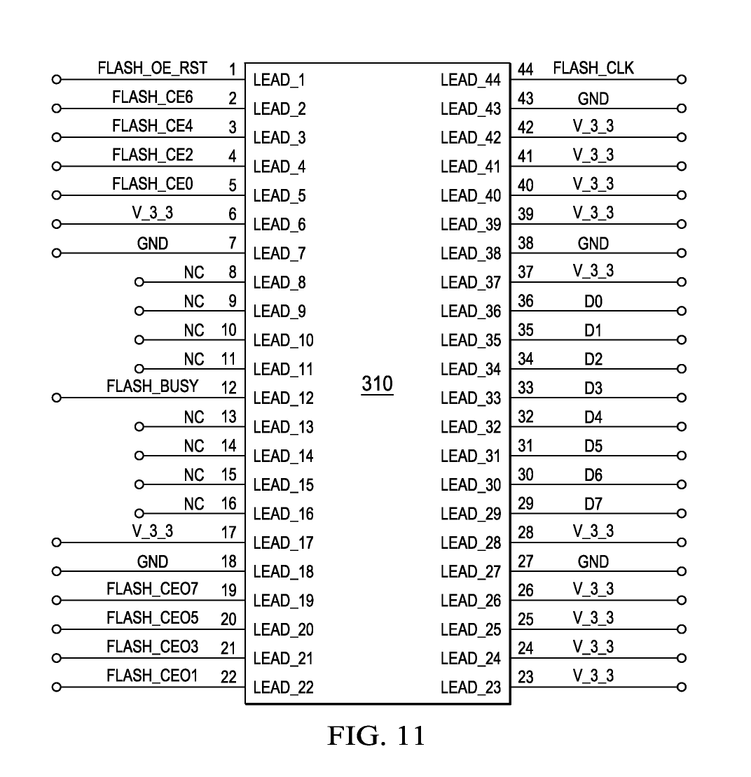

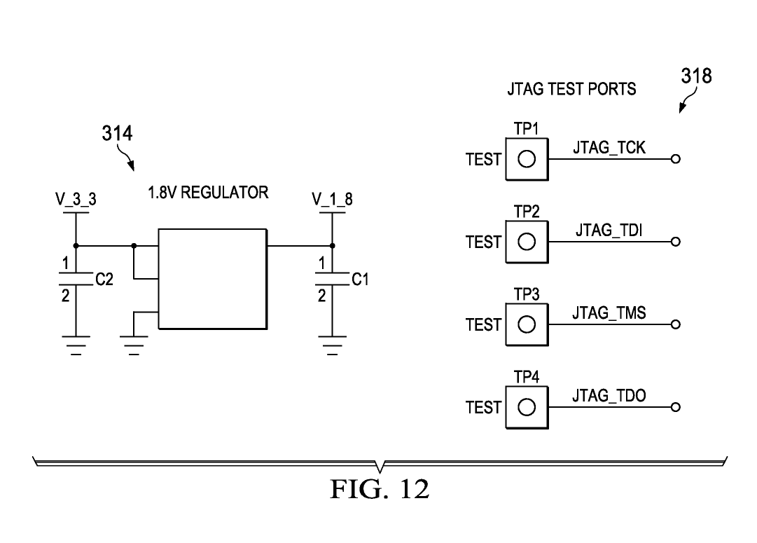

FIG. 11 shows terminal assignments 310 of the SOP44, 0.8 mm pitch footprint terminals of surface mount emulator foot 100. In an embodiment, terminal assignments 310 of SOP44, 0.8 mm pitch footprint of surface mount emulator foot 100 emulate SOP44 terminal assignments of the target PROM, 3D PLUS™ programmable ROM (PROM) module, part number 3DPO64M08VS2299. Various terminal assignments seen in FIG. 11 can be correlated with device terminals of XILINX® XCF32P Flash PROM 302 (FIG. 10). As noted above, the source signals for footprint terminals FLASH CE2, Flash CE4, and Flash CE6 are device terminals of the other three Flash PROMs, and the source signals for footprint terminals FLASH CEO3, Flash CEO5, and Flash CEO7 are device terminals of the other three Flash PROMs (not shown in FIG. 10). The terminal assignments of the footprint terminals for configuration data D0-D7 are obtained by routing the bus signals together for the DATA [0:7] terminals of the four XILINX® XCF32P Flash PROMs.

While various aspects and embodiments have been disclosed, other aspects and embodiments are contemplated. The various aspects and embodiments disclosed are for purposes of illustration and are not intended to be limiting, with the true scope and spirit being indicated by the following claims.

The foregoing method descriptions and the interface configuration are provided merely as illustrative examples and are not intended to require or imply that the steps of the various embodiments must be performed in the order presented. As will be appreciated by one of skill in the art the steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed here may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

What is claimed is:

1. An apparatus for in-system emulation of a target non-volatile memory (target NVM) in a target system, the target NVM being a non-volatile memory device that stores data, and the target NVM being mounted to a surface mount footprint within a volume of the target NVM in the target system, the apparatus comprising:
a device converter including a device converter circuit board and at least one reprogrammable memory device electrically and mechanically coupled to the device converter circuit board; and
a surface mount emulator foot secured to the device converter circuit board, the surface mount emulator foot having a developmental surface mount footprint that emulates the surface mount footprint of the target NVM, and the device converter and surface mount emulator foot fitting within the volume of the target NVM in the target system, the device converter and surface mount emulator foot provide electrical interface routing between device terminals of the at least one reprogrammable memory device and footprint terminals of the surface mount emulator foot to route developmental data stored by the reprogrammable memory device from the device terminals of the at least one reprogrammable memory device to the footprint terminals of the surface mount emulator foot, the developmental data stored by the reprogrammable memory device emulating the data stored by the target NVM.

2. The apparatus of claim 1, wherein the target NVM is a one-time programmable non-volatile PROM device (target PROM).

3. The apparatus of claim 2, wherein the target PROM is configured to store configuration data for configuring the target system and programming data for programming the target system, wherein the at least one reprogrammable memory is configured to store developmental configuration data that emulates the configuration data stored by the target PROM and developmental programming data that emulates the programming data stored by the target PROM, and wherein the device converter and the surface mount emulator foot are configured to route the developmental configuration data and the developmental programming data from the device terminals of the at least one reprogrammable memory device to the footprint terminals of the surface mount emulator foot.

4. The apparatus of claim 2, wherein the target system includes at least one field-programmable gate array (FPGA) device, wherein the at least one reprogrammable memory is configured to store configuration data, and wherein the apparatus for in-system emulation of a target non-volatile memory configures the at least one field-programmable gate array (FPGA) device with the configuration data.

5. The apparatus of claim 1, wherein the device converter circuit board includes a first grid array, wherein the surface mount emulator foot includes a second grid array, and wherein the surface mount emulator foot is secured to the device converter circuit board via electrical and mechanical coupling of the first grid array to the second grid array.

6. The apparatus of claim 5, wherein the first grid array is a micro grid array of socket connectors, and wherein the second grid array is a micro grid array of terminal pins mated with the micro grid array of socket connectors.

7. The apparatus of claim 2, wherein the at least one reprogrammable memory device includes a plurality of flash PROM ball grid array (BGA) packages electrically and mechanically coupled to the device converter circuit board via BGA surface-mounting.

8. The apparatus of claim 7, wherein the device converter circuit board includes joint test action group (JTAG) test connectors electrically coupled to JTAG terminals of the plurality of flash PROM BGA packages.

9. The apparatus of claim 2, wherein the surface mount emulator foot is secured to the device converter circuit board via a grid array located on a first face of the device converter circuit board; and wherein the at least one reprogrammable memory device comprises a first flash PROM ball grid array (BGA) package and a second flash PROM BGA package surface-mounted to the first face of the device converter circuit board, and a third flash PROM BGA package and a fourth flash PROM BGA package surface mounted to a second face of the device converter circuit board.

10. The apparatus of claim 9, wherein the grid array is located at a central location of the first face of the device converter circuit board, and wherein the first flash PROM BGA package and the second flash PROM BGA are surface-mounted at outer locations of the first face of the device converter circuit board.

11. The apparatus of claim 1, wherein the surface mount emulator foot includes an emulator foot circuit board, and wherein the footprint terminals of the surface mount emulator foot are leadless side castellations of the emulator foot circuit board.

12. The apparatus of claim 11, wherein the surface mount emulator foot further includes a surface mount package emulation adapter mounted to the emulator foot circuit board via BGA surface-mounting, and wherein the surface mount emulator foot is secured to the device converter circuit board via electrical and mechanical coupling of the device converter circuit board to a micro grid array of the surface mount package emulation adapter.

13. The apparatus of claim 12, wherein the surface mount emulator foot further includes a protective shroud surrounding the micro grid array of the surface mount package emulation adapter.

14. The apparatus of claim 1, wherein the target NVM is a surface mount package device, and wherein the footprint terminals of the surface mount emulator foot emulate pin assignments of the surface mount package device target NVM.

15. The apparatus of claim 2, wherein the target PROM is a small outline package (SOP) device, and wherein the footprint terminals of the surface mount emulator foot emulate pin assignments of the SOP target PROM.

16. An apparatus for in-system emulation of a target programmable read-only memory (PROM) in a target system, wherein the target PROM is a one-time programmable non-volatile memory device that stores configuration data for configuring the target system and that stores programming data for programming the target system, and wherein the target PROM is a surface mount package device mounted to a surface mount footprint in the target system, the apparatus comprising:
a device converter including a device converter circuit board and a plurality of reprogrammable memory devices electrically and mechanically coupled to the device converter circuit board, the plurality of reprogrammable memory devices configured to store developmental configuration data that emulate the configuration data of the target PROM and store developmental programming data that emulate the programming data stored by the target PROM; and
a surface mount emulator foot secured to the device converter circuit board, the surface mount emulator foot having a developmental surface mount footprint that is configured to emulate the surface mount footprint of the target PROM, the device converter and surface mount emulator foot configured to route the developmental configuration data and the developmental programming data from the plurality of reprogrammable memory devices to the surface mount emulator foot.

17. The apparatus of claim 16, wherein the device converter and surface mount emulator foot are configured to provide electrical interface routing between device terminals of the plurality of reprogrammable memory devices and footprint terminals of the surface mount emulator foot, to route the developmental configuration data and the developmental programming data from the device terminals of the plurality of reprogrammable memory devices to the footprint terminals of the surface mount emulator foot.

18. The apparatus of claim 17, wherein the surface mount emulator foot includes an emulator foot circuit board, wherein the footprint terminals of the surface mount emulator foot are leadless side castellations of the emulator foot circuit board.

19. The apparatus of claim 18, wherein the surface mount emulator foot further includes a surface mount package emulation adapter mounted to the emulator foot circuit board via BGA surface-mounting, wherein the surface mount emulator foot is secured to the device converter circuit board via electrical and mechanical coupling of the device converter circuit board to a micro grid array of the surface mount package emulation adapter.

20. The apparatus of claim 16, wherein the surface mount emulator foot is secured to the device converter circuit board via a grid array located on a first face of the device converter circuit board, and wherein the plurality of reprogrammable memory devices comprise a first flash PROM ball grid array (BGA) package and a second flash PROM BGA package surface-mounted to the first face of the device converter circuit board, and a third flash PROM BGA package and a fourth flash PROM BGA package surface mounted to a second face of the device converter circuit board.
